(19) United States
(12) Patent Application Publication
(10) Pub. No.: US 2013/0141441 A1
(43) Pub. Date: Jun. 6, 2013

(54) DIGITAL SIGNAGE APPARATUS, INFORMATION PROCESSING APPARATUS COMMUNICATING WITH DIGITAL SIGNAGE APPARATUS AND METHOD FOR DISPLAYING CONTENT BY DIGITAL SIGNAGE APPARATUS

(71) Applicant: TOSHIBA TEC KABUSHIKI KAISHA, Tokyo (JP)

(72) Inventor: Kenji Shimizu, Shizuoka-ken (JP)

(73) Assignee: TOSHIBA TEC KABUSHIKI KAISHA, Tokyo (JP)

(21) Appl. No.: 13/666,195

(22) Filed: Nov. 1, 2012

(30) Foreign Application Priority Data
Dec. 2, 2011 (JP) 2011-264530

(51) Int. Cl. G06T 1/00

(52) U.S. Cl. 345/501

(57) ABSTRACT

According to one embodiment, a digital signage apparatus comprises a position information reception unit, a content inquiry unit, a content reception unit and a replay unit. The position information reception unit receives position information capable of specifying the installation position of the own apparatus from an external apparatus. The content inquiry unit notifies the position information received by the position information reception unit to an external information processing apparatus, so as to inquire the distribution of a content corresponding to the installation position. The content reception unit receives the content distributed in response to the inquiry of the content inquiry unit. The replay unit replays the content received by the content reception unit.

### CROSS-REFERENCE TO RELATED APPLICATION

This application is based upon and claims the benefit of priority from Japanese Patent Application No. 2011-264530, filed Dec. 2, 2011, the entire contents of which are incorporated herein by reference.

### FIELD

Embodiments described herein relate to a digital signage apparatus, an information processing apparatus and a method.

### BACKGROUND

In recent years, a digital signage apparatus which replays a content such as an animation or a still picture and the like distributed from a server apparatus to display advertising information for a commodity on a display thereof is installed in a store such as a supermarket, a department store and the like, a commercial facility such as a shopping mall and the like, and a place for selling the commodity, such as a shopping street, an underground street and the like.

### BRIEF DESCRIPTION OF THE DRAWINGS

FIG. 1 is a schematic diagram showing structure of a store operation system;

FIG. 2 is a front view schematically showing an appearance of a digital signage apparatus;

FIG. 3 is a block diagram showing hardware components of a control system of a store server apparatus;

FIG. 4 is a schematic diagram showing one composition example of various tables;

FIG. 5 is a block diagram showing hardware components of a control system of the digital signage apparatus;

FIG. 6 is a block diagram showing functional components of the store server apparatus;

FIG. 7 is a block diagram showing functional components of the digital signage apparatus;

FIG. 8 is a flowchart showing processing operations in the store server apparatus;

FIG. 9 is a flow chart showing processing operations in the digital signage apparatus;

FIG. 10 is a schematic diagram illustrating the automatic switching of a content when the installation position of the digital signage apparatus is changed; and

FIG. 11 is a view showing structure of the store operation system utilizing a cloud system.

### DETAILED DESCRIPTION

According to one embodiment, a digital signage apparatus comprises a position information reception unit configured to receive position information capable of specifying the installation position of the own apparatus from an external apparatus, a content inquiry unit configured to notify the position information received by the position information reception unit to an external information processing apparatus to inquire the distribution of a content corresponding to the installation position specified, a content reception unit configured to receive the content distributed in response to the inquiry of the content inquiry unit, and a replay unit configured to replay the content received by the content reception unit.

According to one embodiment, an information processing apparatus, which communicates with a digital signage apparatus, comprises a position inquiry unit configured to inquire a digital signage apparatus position information capable of specifying the installation position of the digital signage apparatus which is received from the external apparatus by the digital signage apparatus, a specifying unit configured to specify a content corresponding to the installation position of the digital signage apparatus based on the position information notified from the digital signage apparatus in response to the inquiry of the position inquiry unit, and a distribution unit configured to distribute the content specified by the specifying unit to the digital signage apparatus.

Hereinafter, an embodiment is described with reference to the accompanying drawings.

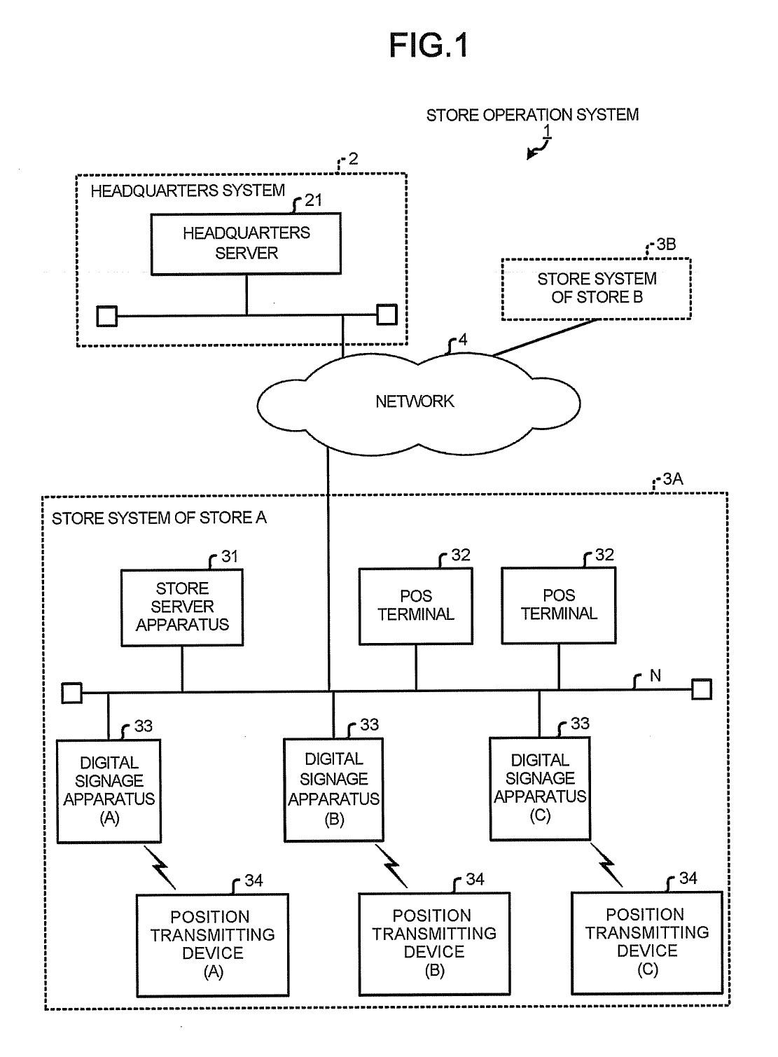

First, schematic structure of a store operation system 1 applying the digital signage apparatus, the information processing apparatus and the method according to the present embodiment are described with reference to the FIG. 1. FIG. 1 is a schematic diagram showing the structure of the store operation system 1.

As shown in FIG. 1, the store operation system 1 comprises a headquarters system 2 and a plurality of store systems 3A and 3B (two store systems for example in FIG. 1). The headquarters system 2 and the store systems 3A and 3B are connected through a public communication network such as an Internet and the like, a network 4 such as a VPN (Virtual Private Network) and the like, or a connecting apparatus such as a router and the like (not shown).

The headquarters system 2 is installed in a headquarters collectively managing each store and comprises a headquarters server 21, a printer, a personal computer and the like (all not shown in the figures).

The store system 3 is installed in each store and comprises a store server apparatus 31, a plurality of POS (Point Of Sales System) terminals 32 (two terminals in FIG. 1), a plurality of digital signage apparatuses 33 (three digital signage apparatuses in FIG. 1) and a plurality of position transmitting devices 34 (three position transmitting devices in FIG. 1), all of which are connected through a communication network N such as a LAN (Local Area Network) and the like.

The store server apparatus 31 is the information processing apparatus, installed in an office and the like of the store, which collectively manages all of the store system 3 as an upper level apparatus. The store server apparatus 31 carries out a sales management based on sales data sent from the POS terminals 32. In addition, the store server apparatus 31 distributes to each digital signage apparatus 33 through the communication network N a content such as an animation or a still picture and the like which is displayed on each digital signage apparatus 33 as an advertising information to advertise commodities sold or services provided to customers in the store and as a guidance information to guide customers to a place where the advertised commodities are sold.

Each POS terminal 32 is the information processing terminal, installed in a checkout counter in the store, which carries out the reception/transmission of commodity information (commodity code, commodity name, unit price and the like) with the store server apparatus 31 through the communication network N to execute the registration and settlement of the commodity purchased by the customer.

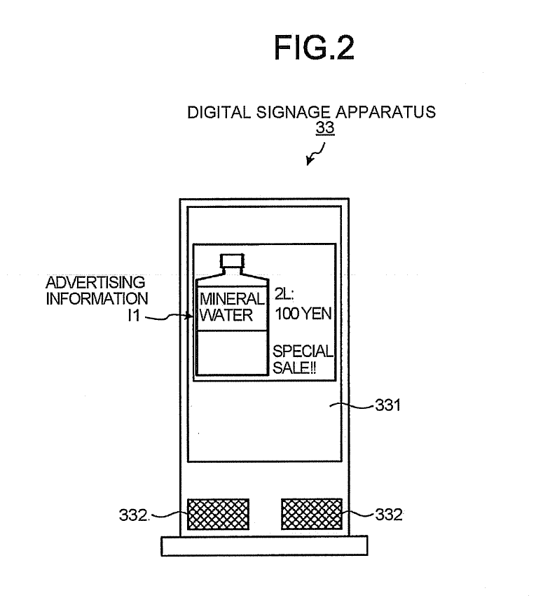

Each digital signage apparatus 33 is installed in a site of the store (a selling floor, an entrance and the like) and replays the content received from the store server apparatus 31 through the communication network N to display various kinds of information on a display section 331 (refer to FIG. 2). More specifically, each digital signage apparatus 33 replays the received content on the display section 331, so as to display the advertising information I1 (refer to FIG. 2) comprising an animation capturing the commodity advertised to customer and an advertising statement for introducing or explaining the commodity and the price thereof to customer, or the guidance information for guiding a route reaching to the place where the advertised commodity is sold or the place where the advertised service is provided to customer. Each digital signage apparatus 33 also outputs an advertising speech for introducing the advertised commodity to customer by a sound output section 332 (refer to FIG. 2).

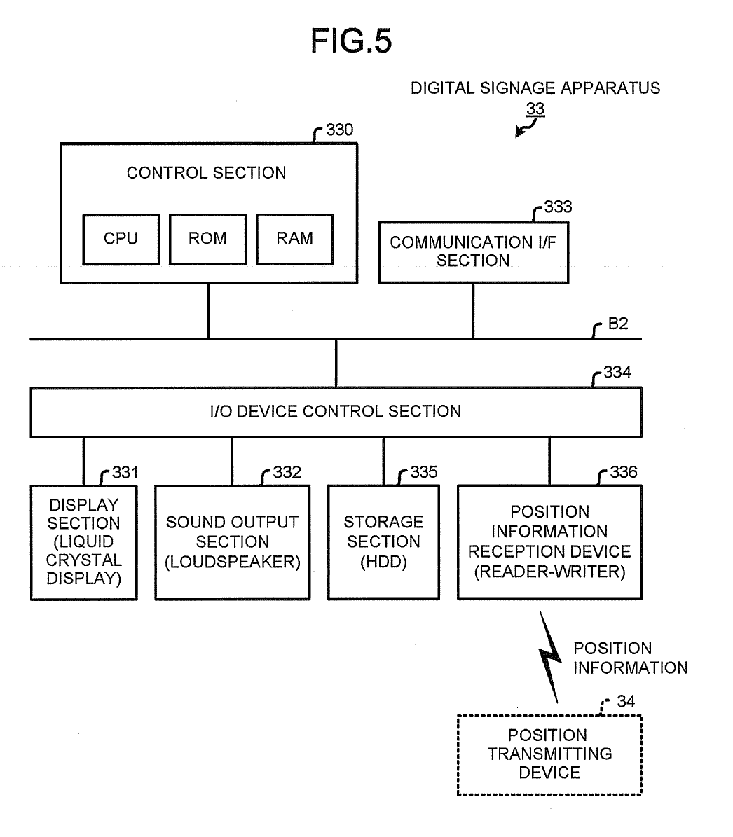

The position transmitting device 34 is a device for sending the own position information, for instance, is realized by an RFID (Radio Frequency Identification) tag comprising a wireless IC chip with an antenna storing the position information of the own device. The digital signage apparatus 33 reads the position information stored in the wireless IC chip by a position information reception apparatus (reader/writer) 336 (refer to FIG. 5) thereof.

Next, the appearance structure of the digital signage apparatus 33 is described referring to FIG. 2. FIG. 2 is a front view schematically showing the appearance structure of the digital signage apparatus 33. As shown in FIG. 2, each digital signage apparatus 33 comprises the display section 331 and the sound output section 332.

The display section 331 displays various kinds of information such as the above-mentioned advertising information or the above-mentioned guidance information and the like based on the received content and is realized by a liquid crystal display or a plasma display and the like. The sound output section 332 outputs various sounds such as a BGM, an advertising speech for introducing the commodity and the like, based on the received content, and is realized by a loudspeaker and the like.

In an example in FIG. 2, only the display section 331 and the sound output section 332 are shown, but it is not limited to that, and each digital signage apparatus 33 also can be set in the form of other structure comprising a printing apparatus (printer) for printing and issuing various tickets, coupons and the like, a reading apparatus for reading information such as the ID and the like of the customer from a storage medium such as a membership card or a cell phone and the like held by the customer, a communication apparatus for carrying out a short-distance communication with the cell phone held by the customer, and an image capturing apparatus (camera) for capturing customer.

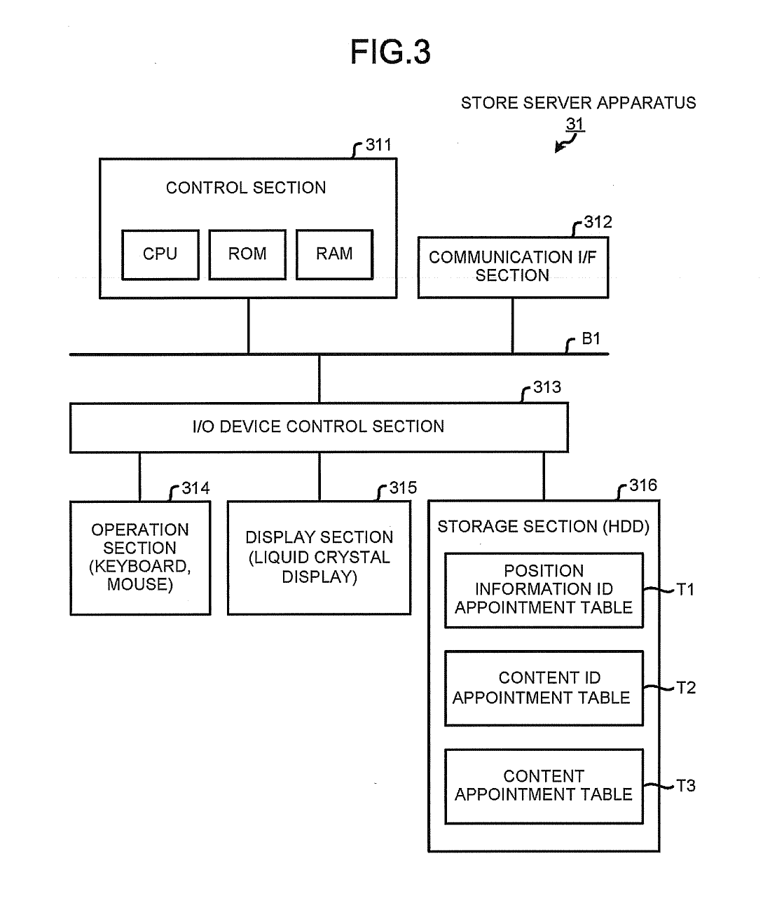

Next, hardware components of a control system of the store server apparatus 31 are described referring to the FIG. 3. FIG. 3 is a block diagram showing the hardware components of the control system of the store server apparatus 31.

As shown in FIG. 3, the store server apparatus 31 is a hardware structure utilizing an ordinary computer and, for instance, is formed with a control section 311, a communication I/F section 312 and an I/O device control section 313 all of which are connected through a bus line B1. The control section 311 comprises a CPU (Central Processing Unit), a ROM (Read Only Memory), a RAM (Random Access Memory) and the like.

The control section 311 is connected with an operation section 314 realized with a keyboard or a mouse and the like, a display section 315 realized with a liquid crystal display and the like, a storage section 316 realized with a hardware device (HDD: Hard Disk Drive) or an SSD (Solid State Drive) device and the like, through the bus line 31 and the I/O device control section 313.

That is, the control section 311 controls operations of various component elements connected via the I/O device control section 313 by developing and carrying out a control program stored in the ROM or the HDD by the CPU. The control section 311 also controls the reception/transmission operation of various data such as the above-mentioned commodity information or the above-mentioned content and the like with the POS terminal 32 or the digital signage apparatus 33 connected through the communication I/F section 312 and the communication network N.

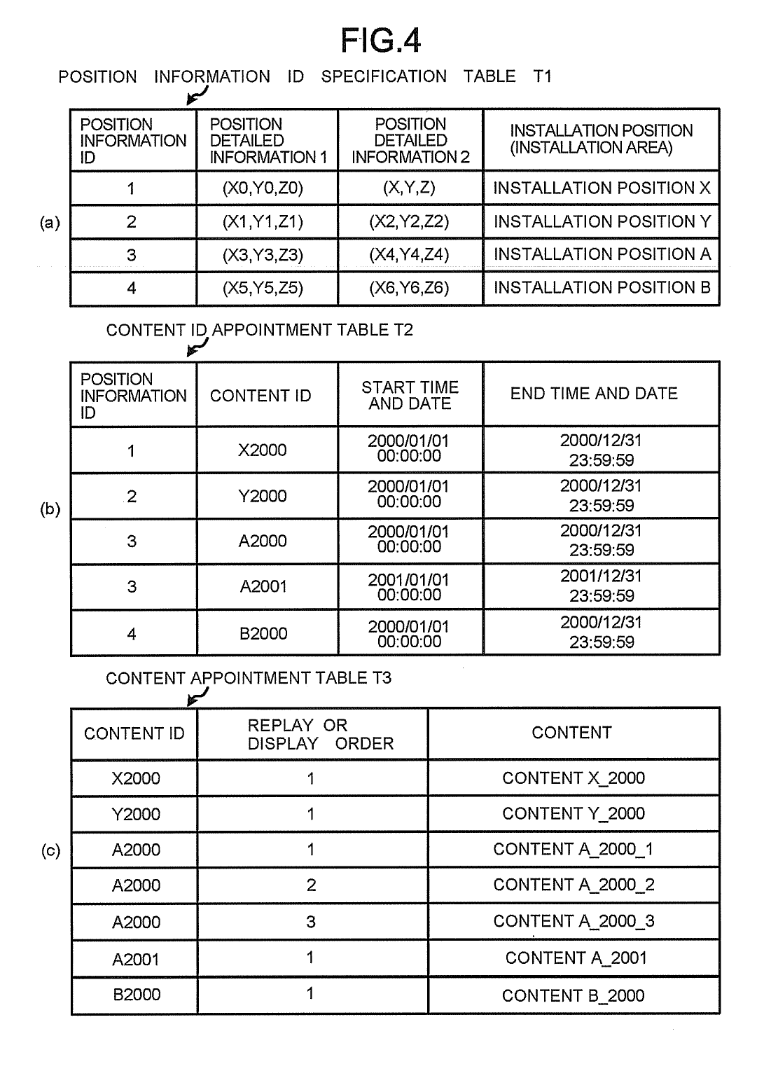

The storage section 316 stores various kinds of information such as a commodity master table for registering the content distributed to each digital signage apparatus 33 and the commodity information (information representing the commodity name and the unit price of the commodity corresponding to the commodity code of each commodity) of each commodity sold in the store, and a sales master table for registering the sales data of the sold commodity (sales information showing the sales volume and the sales amount of each commodity during a certain period such as one business day) based on the sales data received from the POS terminal 33. The storage section 316 also stores a position information ID specification table T1, a content ID specification table T2, and a content specification table T3 (refer to FIG. 4) all of which are described later.

Next, compositions of the position information ID specification table T1, the content ID specification table T2 and the content specification table T3 which are stored in the above-mentioned storage section 316 are described with reference to the FIG. 4.

FIG. 4(a) is a schematic diagram showing one example of the position information ID specification table T1.

As shown in FIG. 4(a), the position information ID specification table T1 is a table for specifying a position information ID corresponding to the above-mentioned installation position (installation positions X, Y, A, B and the like) based on the position information capable of specifying the installation position of each digital signage apparatus 33 notified from each digital signage apparatus 33. Moreover, the position information ID specification table T1 correspondingly registers position detailed information 1 and position detailed information 2 with the position information ID.

Herein, both of the above-mentioned position detailed information 1 and position detailed information 2 are the position information represented by coordinates (X, Y, Z) and the like, and moreover, are the position information for defining each installation position (installation area) (installation positions X, Y, A, B and the like).

That is, the position information ID can be specified by judging the installation position (installation area), to which the position information notified from each digital signage apparatus 33 belongs, which is defined by both of the position detailed information 1 and the position detailed information 2 of each line of the position information ID specification table T1.

FIG. 4(b) is a schematic diagram showing one example of the content ID specification table T2.

As shown in FIG. 4(b), the content ID specification table T2 is a table for specifying a content ID, start time and date and end time and date thereof corresponding to the position information ID based on the position information ID specified in the position information ID specification table T1. Moreover, the content ID specification table T2 correspondingly registers the position information ID with the content ID, the start time and date and the end time and date.

Herein, the above-mentioned content ID is recognition information for specifying the content. In addition, the above-mentioned start time and date and the end time and date mean information which respectively shows the start time and date and the end time and date of the replay of the content specified by the corresponding content ID, that is, information showing the replay period of the content corresponding to the content ID. In an example in FIG. 4(b), the replay period is shown as one year, but is not limited to that, for instance, it may be selected and set from one month, one day, three hours and the like.

FIG. 4(c) is a schematic diagram showing one example of the content specification table T3.

As shown in FIG. 4(c), the content specification table T3 is a table for specifying the content and a replay or display order corresponding to the content ID specified by the above-mentioned content ID specification table T2. Moreover, the content specification table T3 registers the content ID and the replay or display order and the content which correspond to the content ID.

The above-mentioned replay or display order is information showing the replay or display order of the content specified by the content ID. In addition, the above-mentioned content is a content file corresponding to the installation position of the digital signage apparatus 33, and is the content file, including an animation and a still picture for notifying customer of the advertising information which relates to the commodity displayed (sold) near the above-mentioned installation position (within the preset area from the installation position) or the service (massage and the like) offered to customer near the above-mentioned installation position, and the guidance information for guiding the route from the above-mentioned installation position to the place where the commodity is sold or the place where the service is provided to customer by display or voice and the like.

Next, hardware components of a control system of the digital signage apparatus 33 are described with reference to the FIG. 5. FIG. 5 is a block diagram showing the hardware components of the control system of the digital signage apparatus 33.

As shown in FIG. 5, the digital signage apparatus 33 is formed with hardware components utilizing the ordinary computer, for instance, a control section 330, a communication I/F section 333 and an I/O device control section 334 all of which are connected through a bus line 32. In addition, the control section 330 comprises a CPU (Central Processing Unit), a ROM (Read Only Memory), a RAM (Random Access Memory) and the like.

The control section 330 is connected with the display section 331 realized with the liquid crystal display or the plasma display and the like, the sound output section 332 realized with the loudspeaker and the like, a storage section 335 realized with an HDD (hard disk drive), an SSD (Solid State Drive), a nonvolatile memory and the like, and the position information reception device 336 through the bus line 82 and the I/O device control section 334.

That is, the control section 330 controls the operations of various composition elements connected through the I/O device control section 334 and controls the reception/transmission operation of various data such as the content and the like with the store server apparatus 31 connected through the communication I/F section 333 and the communication network N by developing and executing the control program stored in the ROM or the HDD in the RAM by the CPU.

In addition, the storage section 335 stores various kinds of information such as the content received from the store server apparatus 31.

The position information reception device 336 receives the position information capable of specifying the installation position of the own signage apparatus, in which the position information reception device 336 is installed, from the position transmission device (RFID tag) 34. For instance, the position information reception device 336 is realized with the reader/writer as described above and receives the position information from the position transmission device (RFID tag) 34 installed near the own signage apparatus.

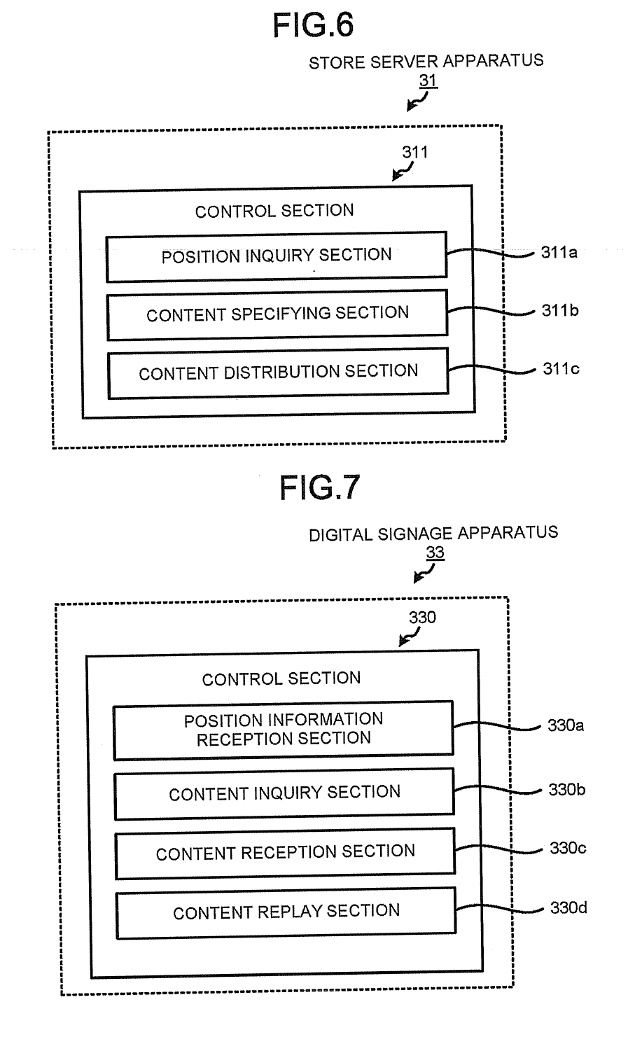

Next, functional components of the store server apparatus 31 are described with reference to the FIG. 6. FIG. 6 is a block diagram showing the functional components of the store server apparatus 31.

As shown in FIG. 6, the control section 311 of the store server apparatus 31 functions as a position inquiry section 311a, a content specifying section 311b and a content distribution section 311c by developing in the RAM a program stored in the ROM and executing the program by the CPU.

The position inquiry section 311a inquires the installation position of each digital signage apparatus 33. More particularly, the position inquiry section 311a inquires each digital signage apparatus 33 about the position information capable of specifying the installation position of each digital signage apparatus 33 and receives the position information from each digital signage apparatus 33. In addition, the position inquiry section 311a receives the position information together with the recognition information (an IP address or a digital signage ID and the like) for recognizing each digital signage apparatus 33.

The content specifying section 311b specifies the content corresponding to the installation position of each digital signage apparatus 33 based on the position information notified from each digital signage apparatus 33 in response to the inquiry of the position inquiry section 311a.

The content specifying section 311b refers to the position information ID specification table T1 based on the position information acquired by the position inquiry section 311b to determine the installation position (installation area), defined by both of the position detailed information 1 and the position detailed information 2 of each line of the position information ID specification table T1, to which the above-mentioned acquired position information belongs and specifies the position information ID corresponding to the installation position (installation area) determined. Afterwards, the content specifying section 311b specifies the content ID, corresponding to the above-mentioned specified position information ID, which includes the current time and day between the start time and date and the end time and date with reference to the content ID specification table T2 based on the above-mentioned specified position information ID and the current time and day. Afterwards, the content specifying section 311b specifies the content and the replay or display order corresponding to the above-mentioned specified content ID with reference to the content specification table T3 based on the above-mentioned specified content ID.

The content distribution section 311c distributes the content (including the replay or display order) specified by the content specifying section 311b to the corresponding digital signage apparatus 33, using the IP address. In addition, the content distribution section 311c further distributes information indicating the end time and date, specified by the content specifying section 311b, which is corresponded to the content when distributing the content. Therefore, in the digital signage apparatus 33, the replay of the corresponding content is discontinued when the current time and day reaches the above-mentioned end time and date.

Next, functional components of the digital signage apparatus 33 are described with reference to the FIG. 7. FIG. 7 is a block diagram showing the functional components of the digital signage apparatus 33.

As shown in FIG. 7, the control section 330 of the digital signage apparatus 33 functions as a position information reception section 330a, a content inquiry section 330b, a content reception section 330c and a content replay section 330d by developing the program stored in the ROM and the like in the RAM and performing the program by the CPU.

The position information reception section 330a receives the position information capable of specifying the installation position where the own signage apparatus is installed. More particularly, the position information reception section 330a acquires, as the position information capable of specifying the installation position of the own signage apparatus, the position information read from the position transmitting device 34 positioned near the own signage apparatus (digital signage apparatus 33) by the position information reception device 336 at a certain timing such as every time that a constant time is passed, and stores the acquired position information in the storage section (HDD) 335 and the like.

The content inquiry section 330b notifies the position information which is received by the position information reception section 330a and stored in the storage section 335 to the store server apparatus 31.

The content reception section 330c receives the content corresponding to the installation position of the own signage apparatus distributed from the store server apparatus 31 according to the notification of the content inquiry section 330b.

The content replay section 330d replays the content received by the content reception section 330c and outputs various kinds of information such as the advertising information or the guidance information and the like based on the content corresponding to the installation position of the own signage apparatus by the display section 331 or the sound output section 332.

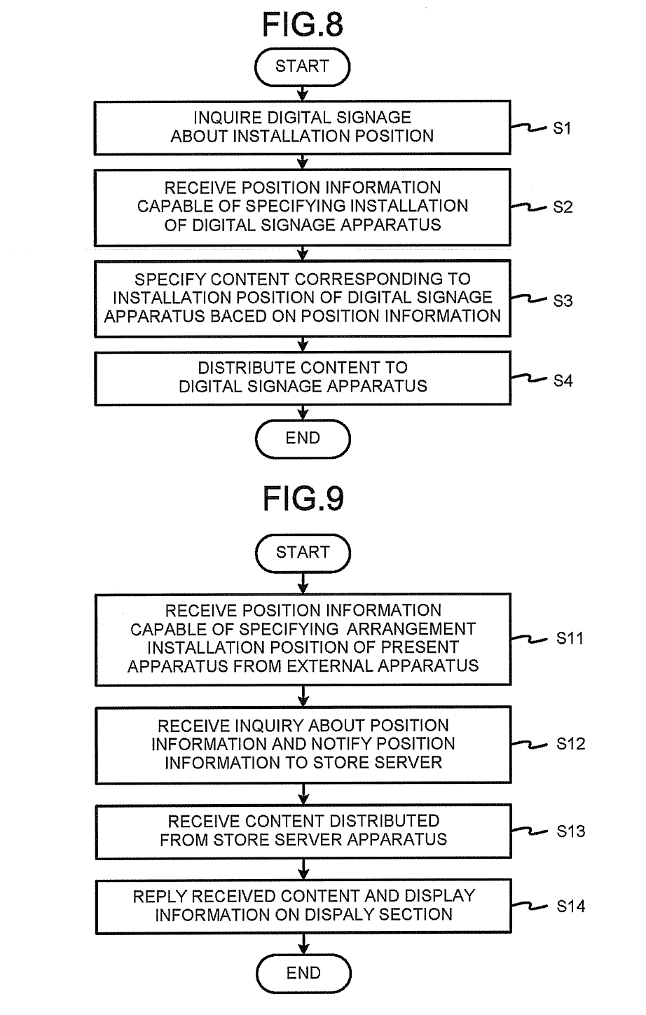

Next, processing operations by the store server apparatus 31 are described with reference to the FIG. 8. FIG. 8 is a flow chart showing the processing operations by the store server apparatus 31.

As shown in FIG. 8, in the store server apparatus 31, the position inquiry section 311a inquires each digital signage apparatus 33 about the installation position thereof, that is, the position information capable of specifying the installation position at a prescribed timing such as each timing that a constant time is passed (Act S1). Afterwards, the position inquiry section 311a receives the position information notified from each digital signage apparatus 33 responding to the inquiry in Act S1 (Act S2).

The content specifying section 311b specifies each content respectively corresponding to the installation position of each digital signage apparatus 33 with reference to the position information ID specification table T1, the content ID specification table T2 and the content specification table T3 based on the position information received in Act S2 (Act S3).

The content distribution section 311c respectively distributes each content specified in Act S3 to the corresponding digital signage apparatus 33, using the IP address (Act S4).

Next, processing operations in the digital signage apparatus 33 are described with reference to the FIG. 9. FIG. 9 is a flow chart showing the processing operations by the digital signage apparatus 33.

As shown in FIG. 9, in each digital signage apparatus 33, the position information reception section 330a receives the position information capable of specifying the installation position where the own signage apparatus is installed from the position transmission device (external device) 34 and stores the received position information in the storage section 335 and the like at a specified timing such as each time that a constant time is passed (Act S11).

The content inquiry section 330b notifies the position information stored in the storage section 335 in Act S11 to the store server apparatus 31 if the content inquiry section 330b receives from the store server apparatus 31 inquiry of the position information of the own signage apparatus capable of specifying the installation position thereof (Act S12).

The content reception section 330c then receives the content corresponding to the installation position of the own signage apparatus distributed from the store server apparatus 31 responding to the notification in Act S12 (Act S13).

Next, the content replay section 330d replays the content received in Act S13, so as to display various kinds of information such as the advertising information or the guidance information and the like on the display section 331 based on the content corresponding to the installation position of the own signage apparatus (Act S14).

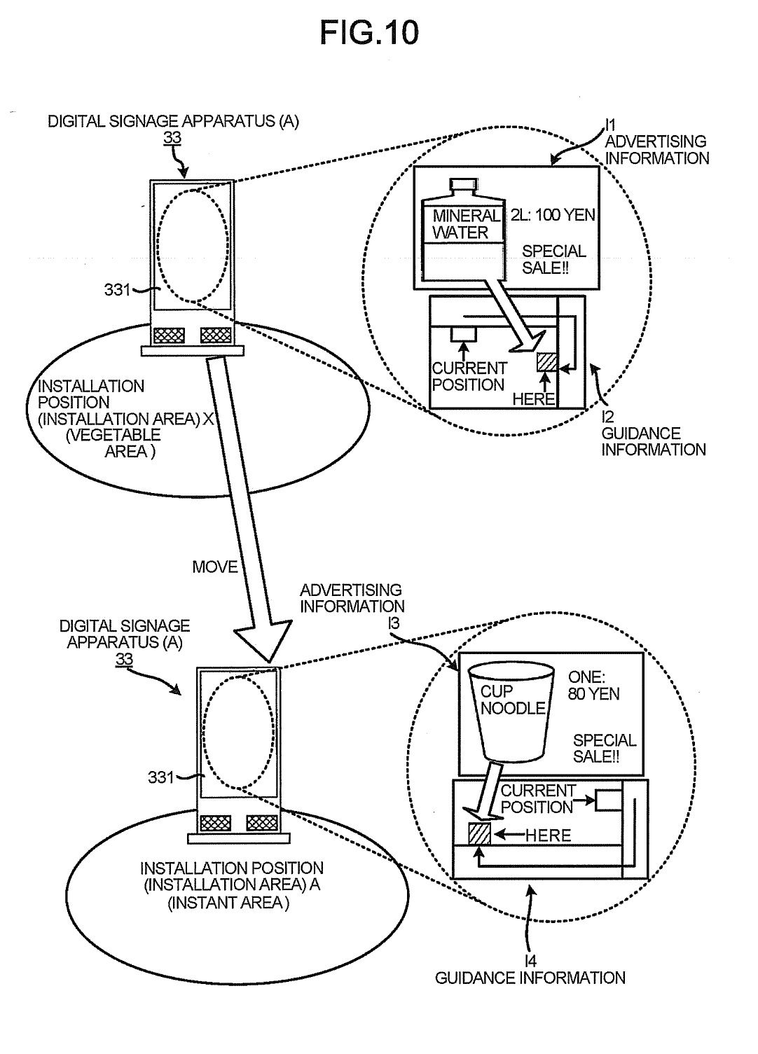

One example of the concrete processing operations in FIG. 8 and FIG. 9 is described with reference to the FIG. 10. FIG. 10 is a schematic diagram explaining the following situation that the content replayed by the digital signage apparatus (A) is automatically switched from the content corresponding to the installation position X to the content corresponding to the installation position A without the manual operation by the store clerk if the installation position of the digital signage apparatus (A) 33 is changed to the installation position (installation area) A from the installation position (installation area) X by the store clerk.

Hereinafter, the following case that the store server apparatus 31 inquires the digital signage apparatus (A) 33 about the installation position thereof after the digital signage apparatus (A) 33 is moved to the installation position A from the installation position X by the store clerk is described with reference to FIG. 10.

In an example in FIG. 10, before the installation position of the digital signage apparatus (A) 33 is changed, that is, in case that the digital signage apparatus is arranged at the installation position X, the display section 331 displays the advertising information I1 in which the commodity such as “mineral water” is advertised to customer based on the content (content X_{—}2000) (refer to FIG. 4) corresponding to the installation position X, and moreover, the price of the commodity advertised is 100 yen under the special sales is notified to customer and the guidance information 12 in which the route from the place where the digital signage apparatus (A) 33 is installed to the place where the commodity, “mineral water”, is displaed is guided to customer.

In such a case as described above, in the store server apparatus 31, first, in Act S1 in FIG. 8, the position inquiry section 311a inquires the digital signage apparatus (A) 33 the position information capable of specifying the installation position of the subject signage apparatus. Afterwards, in Act S2, the position inquiry section 311a receives the position information (X3, Y3, Z4), for example, notified from the subject digital signage apparatus (A) 33 in response to the inquiry issued in Act S1. Wherein, the position information (X3, Y3, Z4) is a coordinate information included in the installation position (installation area) A defined by the position detailed information 1 (X3, Y3, Z3) and the position detailed information 2 (X4, Y4, Z4) of the table T1 (refer to FIG. 4(a).

In Act S3, the content specifying section 311b judges that the received position information belongs to the installation position (installation area) A defined by the position detailed information 1 (X3, Y3, Z3) and the position detailed information 2 (X4, Y4, Z4) in the third line of the position information ID specification table T1 and specifies the position information ID “3” corresponding to the installation position A with reference to the position information ID specification table T1 (refer to FIG. 4 (a)) based on the position information received in Act S2.

After that, the content specifying section 311b specifies the content ID (which is a content ID “A2000” rather than a content ID “A2001” in this case) corresponding to the position information ID “3” and including the current time and date (for example, “2000/01/02 00:00:00”) in the start time and date and the end time and date pair with reference to the content ID specification table T2 (refer to FIG. 4(b)) based on the above-mentioned specified position information ID “3”.

The content specifying section 311b then specifies “content A_{—}2000_{—}1”, “content A_{—}2000_{—}2” and “content A_{—}2000 3” as the content corresponding to the content ID “A2000” with reference to the content specification table T3 (refer to FIG. 4(c)) based on the above-mentioned specified content ID “A2000”. In addition, the replay or display order of each content is further specified.

After that, the content distribution section 311c distributes the contents, that is, the “content A_{—}2000_{—}1”, the “content A_{—}2000_{—}2” and the “content A_{—}2000_{—}3”, specified in Act S3 together with the information showing the replay or display order to the subject digital signage apparatus (A) 33, using the IP address.

On the other hand, in Act S11 in FIG. 9, when the installation position of the signage apparatus (A) 33 is changed to the installation position A from the installation position X by the store clerk, the position information reception section 330a receives the position information (X3, Y3, Z4, for example) from the position transmission apparatus 34 (external apparatus) positioned in the vicinity of the own signage apparatus and stores the position information in the storage section 335. In other words, the digital signage apparatus (A) 33 stores the above-mentioned position information (X3, Y3, Z3) as the coordinate information capable of specifying the installation position A where the own signage apparatus is installed.

After that, the content inquiry section 330b notifies the position information (X3. Y3, Z4) of the own signage apparatus (A) stored in the storage section 335 in Act S11 to the store server apparatus 31 when the content inquiry section 330b receives the inquiry of the position information from the store server apparatus 31.

The content reception section 330c then receives the contents including the “content A_{—}2000_{—}1”, the “content A_{—}2000_{—}2”, the “content A_{—}2000_{—}3” and the information showing the replay or display order as the content corresponding to the installation position of the own signage apparatus (A) distributed from the store server apparatus 31 based on the notification in Act S12 (Act S13).

The content replay section 330d replays the contents (the “content A_{—}2000_{—}1”, the “content A_{—}2000_{—}2” and the “content A_{—}2000_{—}3”) received in Act S13 according to the replay or display order to display the advertising information and the guidance information based on the content corresponding to the installation position of the own signage apparatus on the display section 331 thereof.

That is, in the example in FIG. 10, for instance, in case that the digital signage apparatus (A) is moved to the installation position A, the digital signage apparatus (A) displays on the display section 331 the advertising information 13 for advertising the commodity such as “cup noodle” together with the price (80 Yen) thereof under the special sales to customer and the guidance information 14 for guiding a route from the place where the own digital signage apparatus (A) 33 is installed to the place where the commodity such as the “cup noodle” is displayed to customer according to the above-mentioned “content A_{—}2000_{—}1”.

According to the embodiment described above, when the installation position of the digital signage apparatus (A) 33 is changed by the store clerk and the like, the content replayed on the digital signage apparatus (A) 33 is automatically switched to the content corresponding to the changed installation position without the manual operation by the person such as the store clerk and the like.

Hereinbefore, the embodiment is described according to the examples, but the present invention is not limited to the above-mentioned embodiment.

For instance, in the above-mentioned embodiment, even though not being described specially, each digital signage apparatus 33 may include a set-top box, and the set-top box may also realize each function composition section shown in FIG. 7.

In the above-mentioned embodiment, the way that the content replayed on each digital signage apparatus 33 is automatically changed to the content corresponding to the installation position by the inquiry to each digital signage apparatus 33 about the installation position (that is, the position information capable of specifying the installation position) by the store server apparatus 31 is described, but is not limited to that, for instance, the following way that the content replayed on each digital signage apparatus 33 is automatically changed to the content corresponding to the installation position by notifying the position information capable of specifying the installation position of the own apparatus to the store server apparatus 31 from each digital signage apparatus 33 to inquire the content corresponding to each installation position may also be adopted.

Particularly, in the above-mentioned modification example, for instance, in the functional components shown in FIG. 7, the content inquiry section 330b may be modified to a content inquiry section (content inquiry unit) which notifies the position information received by the position information reception section 330a to the external store server apparatus 31 and inquires the distribution of the content corresponding to the installation position at a prescribed timing such as each time that a constant time is passed or the own signage apparatus starts, and in the functional components shown in FIG. 6, the position inquiry section 311a may also be modified to a position information reception section (position information reception unit) which receives the position information notified by the above-mentioned content inquiry section.

In the above-mentioned embodiment, the case that the position transmission device 34 is an RFID tag, the position information reception device 336 of each digital signage apparatus 33 reads the position information from the RFID tag and thus each digital signage apparatus 33 acquires position information capable of specifying the installation position of each digital signage apparatus is described, but is not limited to that, and the position information may also be acquired by use of other communication technologies.

For instance, the following way that the position transmission device 34 is to be a device transmitting the position information in a GPS signal form with an indoor GPS (Global Positioning System) function, the position information reception device 336 of each digital signage apparatus 33 receives the position information in the above-mentioned GPS signal form, and thus each digital signage apparatus 33 acquires the position information capable of specifying the installation position of each apparatus may also be adopted. Moreover, each digital signage apparatus 33 may also acquire the position information stored in the storage section 335 set by the manual operation of the store clerk.

The program performed by the store server apparatus 31 or the digital signage apparatus 33 of the above-mentioned embodiment may be provided in the form that the program is previously stored in the storage unit such as a ROM. In addition, the above-mentioned program may be provided in the form that the program is stored in a computer-readable storage medium with a file in an installable format or an executable format. In addition, the above-mentioned program may also be provided or distributed through the network such as the internet and the like.

In the above-mentioned embodiment, the case that the store server apparatus 31 performs the processing shown in FIG. 8 is described, but is not limited to that, and the headquarters server 21 comprises the function composition section shown in FIG. 6, and may also perform the processing shown in FIG. 8.

In addition, operations as mentioned above may also be realized by the store operation system including a terminal apparatus and a server apparatus. In such a case, one server apparatus may perform processes for realizing the interrupt advertising in one or plural digital signage apparatuses, or plural server apparatuses may share processes for realizing the interrupt advertising in the one or the plural digital signage apparatuses.

To realize such a store operation system, the cloud computing may be utilized. More particularly, a software providing service called as software as a service (SaaS) is suitable.

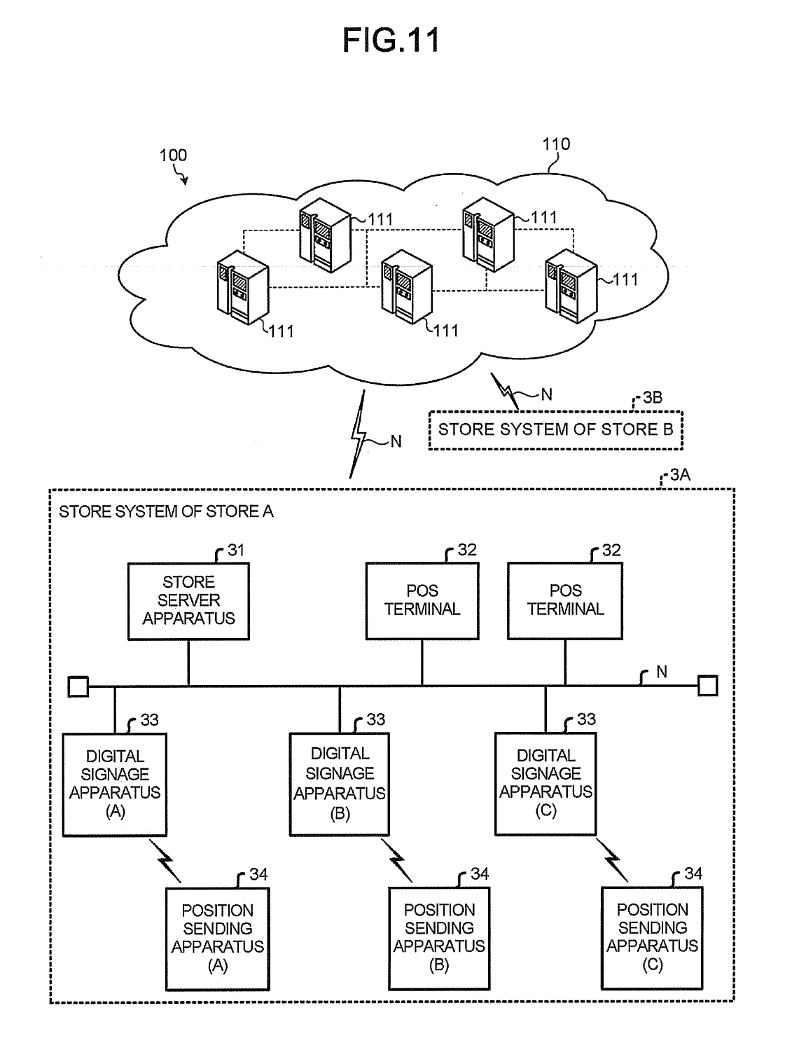

FIG. 11 is a view showing constitution of a store operation system 100 utilizing a cloud system. As shown in FIG. 11, the store operation system 100 comprises a cloud 110, and a plurality of communication networks N for connecting the store system 3A of a store A, the store system 3B of a store B, and the like, to the could 110. In addition, the number of store system 3 and communication network N may be respectively one.

The cloud 110 further comprises a plurality of server apparatuses (information processing apparatuses) 111. The plurality of server apparatuses 111 are formed to be capable of mutually communicating. However, the number of server apparatus 111 may be only one.

The digital signage apparatus 33 of the store system 3 can communicate with the cloud 110 through the communication network N. Internet, a private network, a next generation network (NGN) or a mobile network and the like can be utilized properly as a communication network N. In addition, in the store operation system 100, each function composition section shown in FIG. 6 is realized by the cloud 110.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A digital signage apparatus, comprising:
a position information reception unit configured to receive position information capable of specifying the installation position of the own apparatus from an external apparatus;
a content inquiry unit configured to notify the position information received by the position information reception unit to an external information processing apparatus to inquire the distribution of a content corresponding to the installation position specified;
a content reception unit configured to receive the content distributed in response to the inquiry of the content inquiry unit; and
a replay unit configured to replay the content received by the content reception unit.

2. An information processing apparatus which communicates with the digital signage apparatus claimed in claim 1, comprising:
a position inquiry unit configured to inquire the digital signage apparatus the position information capable of specifying the installation position of the digital signage apparatus which is received from the external apparatus by the digital signage apparatus;
a specifying unit configured to specify a content corresponding to the installation position of the digital signage apparatus based on the position information notified from the digital signage apparatus in response to the inquiry of the position inquiry unit; and
a distribution unit configured to distribute the content specified by the specifying unit to the digital signage apparatus.

3. The information processing apparatus according to claim 2, wherein the content corresponding to the installation position notifies an advertising information relevant with a commodity sold or a service provided near the installation position of the digital signage apparatus.

4. The information processing apparatus according to claim 2, wherein
the content corresponding to the installation position notifies a guidance information for guiding from the installation position of the digital signage apparatus to a place at which an advertised commodity is sold or a place at which an advertised service is provided.

5. A method for displaying content by a digital signage apparatus, comprising:
receiving position information capable of specifying the installation position of the own apparatus from an external apparatus;
notifying the position information received to an external information processing apparatus to inquire the distribution of a content corresponding to the installation position of the own apparatus;
receiving the content from the external information processing apparatus in response to the inquiry of the content; and
replaying the content received.

6. A method for distributing content by an information processing apparatus, comprising:
inquiring a digital signage apparatus a position information capable of specifying the installation position of the digital signage apparatus;
specifying a content corresponding to the installation position of the digital signage apparatus based on the position information notified from the digital signage apparatus in response to the inquiry of the position information; and
distributing the content specified to the digital signage apparatus.
